(19) United States
(12) Patent Application Publication
(10) Pub. No.: US 2021/0110410 A1
(43) Pub. Date: Apr. 15, 2021

(54) METHODS, SYSTEMS, AND APPARATUSES FOR PROVIDING DATA INSIGHT AND ANALYTICS

(71) Applicant: VISA INTERNATIONAL SERVICE ASSOCIATION, San Francisco, CA (US)

(72) Inventors: Arnab Dutta, Sunnyvale, CA (US); Mohit Kudalkar, Milpitas, CA (US)

(21) Appl. No.: 16/599,770

(22) Filed: Oct. 11, 2019

(51) Int. Cl. G06Q 30/02; G06Q 30/06

(52) U.S. Cl. CPC G06Q 30/0201; G06Q 30/0281; G06Q 30/0629

(57) ABSTRACT

A method for displaying data on a computing device having a graphical user interface is disclosed. A selection of a merchant is received from a user via a user selection button displayed on the graphical user interface. A peer group for the merchant is determined. The peer group is comprised of one or more peer merchants that are in the same industry as the merchant. A first dataset having one or more merchant variables for the merchant is received. A second dataset having one or more peer variables for the peer group is received. The first dataset is analyzed to determine if one or more anomalies are present in the first data set. If one or more anomalies are present, the anomalies are removed. The one or more merchant variables and the one or more peer variables are displayed on a graphical user interface.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Salespersons in the field often have to provide real time data to customers or potential customers in order to obtain a sale or provide valuable information to a current customer to maintain the relationship. To effectively communicate with a client or potential client, the data needs to be presented in a visually appealing manner that is easy to understand. The data also needs to be as current and clean as possible in order to provide an accurate depiction of the current landscape for a merchant or industry.

Additionally, a salesperson may or may not be technically savvy or have a strong background in data analytics so a tool that is intuitive and easy to use is needed. Further, salespersons may be traveling with a laptop or other computing device with a limited sized monitor or display screen. The salesperson may also have a limited time to meet with current and potential customers. Thus, the salesperson needs to be able to present information in an efficient manner without having to scroll down a screen or move between various pages of a web-based sales application tool.

Accordingly, there exists a need to establish a tool that incorporates past and current transaction and merchant data, scrubs the data to remove anomalies, and displays the data in a meaningful way that is visually easy to understand. There also exists a need for an analytics tool that is displayed on a single screen that can be accessed at any time.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, a method for displaying data on a computing device having a graphical user interface is disclosed. A selection of a merchant is received from a user via a user selection button displayed on the graphical user interface. A peer group for the merchant is determined. The peer group is comprised of one or more peer merchants that are in the same industry as the merchant. A first dataset having one or more merchant variables for the merchant is received. A second dataset having one or more peer variables for the peer group is received. The first dataset is analyzed to determine if one or more anomalies are present in the first data set. If one or more anomalies are present, the anomalies are removed. The one or more merchant variables and the one or more peer variables are displayed on a graphical user interface.

### BRIEF DESCRIPTION OF THE DRAWINGS

The example embodiment(s) of the present disclosure are illustrated by way of example, and not in way by limitation, in the figures of the accompanying drawings and in which like reference numerals refer to similar elements and in which:

FIG. 1 is an exemplary graphical user interface illustrating a web-based tool for providing data insights and analytics;

FIG. 2 is a flow chart of an embodiment of a method for displaying data on a computing device having a graphical user interface;

FIG. 3 is a schematic illustration of elements of an example system according to the present disclosure; and,

FIG. 4 is a block diagram of system components of a computing device in accordance with the present disclosure.

The figures depict various embodiments for purposes of illustration only. One skilled in the art may readily recognize from the following discussion that alternative embodiments of the structures and methods illustrated herein may be employed without departing from the principles described herein. For example, other embodiments may omit, add to, reorder, and/or modify any of the elements shown in the figures.

### DETAILED DESCRIPTION

At a high level, the systems, methods, and apparatuses described herein display data on a graphical user interface to provide analytics and insights to salespersons, merchants, and other individuals with respect to, for example, how a specific merchant or market segment is performing. For example, a salesperson may want to do a market study, merchant benchmarking, or prepare merchant reports. In addition, a merchant may want to know how much of its transactions are card transactions v. no card transaction and how it is doing compared to its competitors in a specific geographic location. The systems, methods and apparatuses of the present disclosure can be used to display the relevant data requested in a visual manner, for example, in graphical form. The systems, methods, and apparatuses may further display the data on a single screen to allow for quick and easy access. The single screen display is advantageous as it eliminates the need to scroll down or navigate between pages thereby providing the information quickly and efficiently.

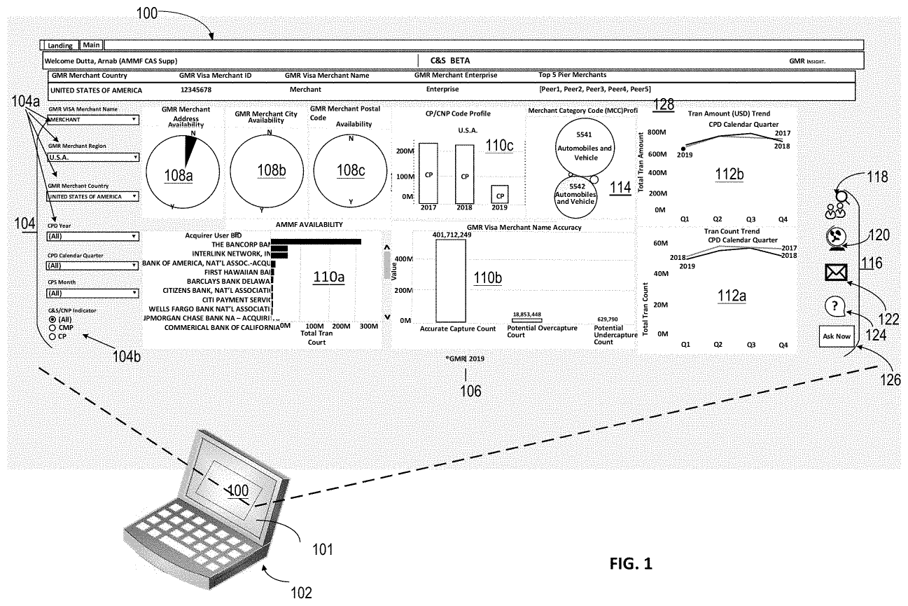

FIG. 1 is an embodiment of a graphical user interface (GUI) 100 that may be displayed on a display 101 of a computing device 102 and used by a user. The computing device 102 may be a laptop, tablet, cellphone, or other portable computing device. Alternatively, the computing device 102 may be a desktop computer. The GUI 100 may be a single webpage having no global scroll bars (e.g., scroll bars that move the entire page up or down). The GUI 100 may be a web based tool that is available at any time.

Displayed on the GUI 100 may be one or more user selection buttons 104 such as drop down menus 104a or radial buttons 104b. The user selection buttons 104 may be displayed vertically along the left hand side of the GUI 100 as shown in FIG. 1 or along the right hand side. The user selection buttons 104 may also be displayed horizontally along the top or bottom of the GUI 100.

The GUI 100 may also have one or more graphs 106. The graphs 106 may be in the form of one or more pie charts 108a, b, c, bar graphs 110a, b, c, line graphs 112a,b, or other diagram 114, for example, an Euler or Venn diagram. The graphs 106 may display data comprising one or more variables that relate to a merchant, the merchant's peer group, the merchant's industry, or to a geographic location. For example, the graphs may display merchant address availability, merchant city availability, merchant postal code availability, acquirer availability, card present/not present profile, MCC profile, transaction amount, and merchant name accuracy.

The graphs 106 may be in contrasting colors. For example, for any graphs that show data responsive to a “Yes/No” inquiry may display “Yes” data in green and “No” data in red.

One or more widgets 116 may also be displayed on the GUI 100. The one or more widgets 116 may be vertically oriented along the right hand side of the GUI 100. The one or more widgets 116 may be vertically oriented along the left hand side of the GUI 100 or horizontally oriented along the top or bottom of the GUI 100. The one or more widgets 116 may include a search widget 118, a map or geolocation widget 120, a communication widget 122, a help widget 124, or a support widget 126. The search widget 118 may enable the user 102 to search for various information including, for example, merchant names and addresses, merchant category codes (MCCs), merchant enterprise information, peer merchants, card present v. card not present transactions, overall transaction volume and amount. The map or geolocation widget 120 may enable the user 102 to, for example, locate merchants or peer merchants in a particular city, state, country, or region. The communication widget 122 may enable a user to send feedback and other information they obtain during a client or potential client meeting either from the client or during use of the GUI to a data analytics team or directly to one or more merchant databases 310 so that the obtained information can be incorporated or added to the dataset for the client or potential client. The help widget 124 may be used to obtain instructions on how to use different features of the GUI or to explain what the various graphs show. And, the support widget 126 may provide a live chat tool, which enables the user to ask questions to a client support or data analytics team or to report issues.

A merchant information bar 128 may be horizontally oriented along the top of the GUI 100. The merchant information bar 128 may alternatively be horizontally oriented along a bottom of the GUI 100 or vertically oriented along either the left hand or right hand sides of the GUI 100. The merchant information bar 128 may display, for example, the location (e.g., country) of the merchant that is the client or potential client, the merchant's identification number, the merchant's name, the merchant's enterprise, and one or more peer merchants. Peer merchants may be merchants that are in the same industry as the merchant or the same geographic location. The industry may be determined based on the MCCs, in which the merchant or peer merchants operate.

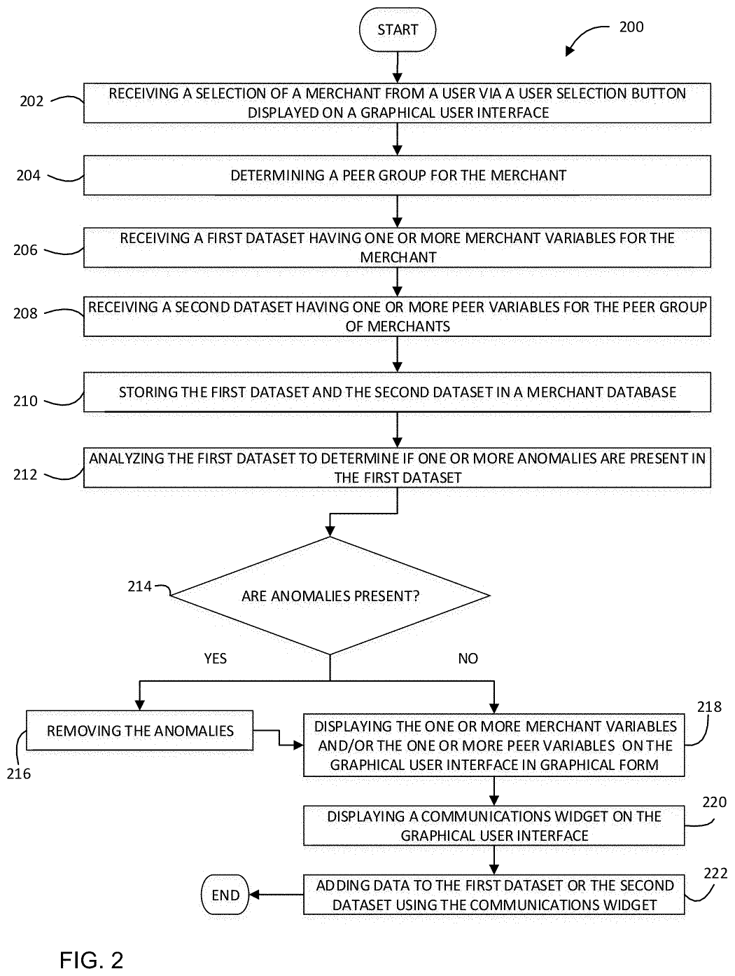

FIG. 2 generally illustrates an embodiment of a method 200 for displaying data via a GUI on a computer device. The computing device may be a device such as computing device 102 having display screen 101. The GUI may be a GUI such as GUI 100. At a block 202, a selection of a merchant (e.g., a client or potential client) via a user selection button may be made by a user. The user selection button may be displayed on the GUI. For example the user selection button may be one or more of the user selections 104 as shown in FIG. 1.

At a block 204, a peer group of the merchant is determined. The peer group may be one or more merchants that operate in the same industry as the merchant. In one embodiment, a peer group of merchants may include competitors of the merchant that operate in one or more of the same MCC's as the merchant. In other embodiments, the peer groups may be in a similar geographic location. In yet another embodiment, the peer groups may be similar in size. In yet another embodiment, the peer groups may have a similar average sale amount. In another embodiment, machine learning may be used to identify peer merchants based on the desires of the user. Of course, other ways of determining a peer group are possible and are contemplated.

At a block 206, a first dataset having merchant data including one or more merchant variables may be received for the merchant. The first dataset may be received from a first acquirer. The first dataset may include but not be limited to merchant data such as merchant name, MCCs, transactions performed including those that are card present versus card not present, transaction amount, and location information for the merchant including address, city and postal code.

At a block 208, a second dataset having peer merchant data including one or more peer variables may be received for the peer group. The second dataset may be received from a second acquirer. The first acquirer and the second acquirer may be the same acquirer or a different acquirer. The second data set may include but not be limited to peer merchant data such as peer merchant name(s), peer merchant MCCs, transactions performed including those that are card present versus card not present at the peer merchant(s), transaction amount for each peer merchant, and location information for the peer merchant(s) including address, city and postal code. The first and second datasets may also include acquirer data for the respective merchants such as acquirer availability.

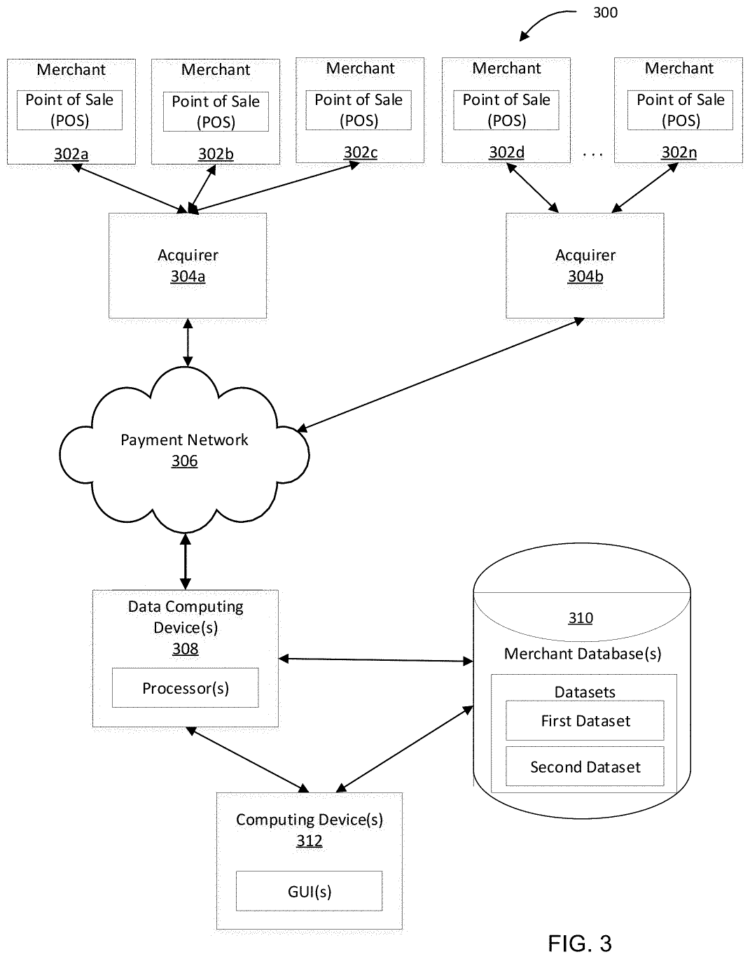

At a block 210 the first and second datasets may be stored in one or more merchant databases 310. The one or more merchant databases 310 may be in communication with one or more data computing devices 308 and computing devices 312, such as computing device 102 (see FIG. 3).

At a block 212, the first dataset may be analyzed to determine if one or more anomalies exists in the first dataset. Anomalies may take on a variety of forms or values. In general, anomalies may be data that does not belong in a dataset. In one embodiment, anomalies may simply be errors such as an error in typing, an error in decoding a communication, or an error in storage. In another embodiment, the anomaly may include data which may not have errors but may have been stored in an incorrect file location or under an incorrect file name. For example, an auto parts store is unlikely to store data about fresh fruit and a fruit store is unlikely to store data about auto parts. Similarly, a store in the United States will likely store values in dollars rather than Euros. In yet another example, the data may simply be garbled and the descriptions may make no sense.

However, some names may be garbled on purpose as a marketing draw or to avoid trademarks or to have a unique URL. Trying to determine what an anomaly is and what a purposeful misspelling is may be a technical challenge as simple comparisons to known words may flag anomalies, which are not really anomalies.

At a block 214 whether one or more anomalies are present in the second dataset may be determined. In one embodiment, whether one or more anomalies exist may be determined by comparing the first dataset to the second dataset. The one or more merchant variables of the first dataset may include a plurality of MCCs for the merchant in a first location; and, the one or more peer variables of the second dataset may include a plurality of peer merchant category codes for one or more peers of the merchant in the first location. An anomaly may exist if any of the MCCs from the plurality of merchant category codes does not match any of the peer MCCs from the plurality of peer merchant category codes. The first location may be a city, state, country, or region.

In another embodiment, whether one or more anomalies exists may be determined by comparing the one or more merchant variables of the first dataset. For example, the one or more merchant variables of the first dataset may comprise a first plurality of MCCs of the merchant at a first location and a second plurality of MCCs for the merchant at a second location. The first location may be the same or different than the second location. An anomaly may exist if any of the merchant category codes from the first plurality of merchant category codes does not match any of the merchant category codes from the second plurality of merchant category codes.

The comparison also may include a ranking or weighting of the merchant variables, which may be used to calculate a match rating. For example, the weighting on a first piece of data evaluated between the merchant variables may be given a heavier weight than a second piece of data evaluated between the variables in the first and second datasets. In application, an insignificant difference may be given a lower weight and the overall match rating score of the comparison still may be over a match rating threshold notwithstanding the insignificant difference. In a similar manner, difference in a heavily weighted merchant variable may result in a match rating score below a match rating threshold and the anomaly may be noted. Logically, the weighting may be adjusted by users over time as experience may assist in determining which weights indicate an important anomaly and which weights indicate an insignificant anomaly. Similarly, machine learning may be used to adjust the weights by studying past events and past determinations to make better weighting decisions in the future.

Machine learning may also be used to evaluate whether the differences in datasets indicates an anomaly or just represents the facts of a situation. For example, a chain store near a school may not be able to sell alcohol while another branch of the same chain may be able to sell alcohol. By reviewing the data about stores near schools, machine learning may be able to determine that the difference in data may relate to one store being near a school and the data may not contain anomalies. By studying past transactions and data, machine learning may be able to eliminate some false anomaly determinations.

If an anomaly exists, then in may be removed at a block 216. For example, if the anomaly is an incorrect MCC for the first location, then the MCC stored in the dataset for the first location may be updated to the correct MCC. Similarly, if the MCC for the first location for a merchant does not match any of the MCCs for any other locations then the MCC may be corrected. If no anomalies exist, then the method may proceed to a block 218.

At a block 220, one or more widgets 116, for example communication widget 122, may be displayed on the GUI 100. Widgets may be graphical representations of code sections which perform an action. As an example, the communication widget may represent that communication should occur. By selecting a widget, the user does not have to understand code commands or data formats as the widget may take care of the technical details for a user.

At a block 222, a user may add data to the first dataset using the widget. The data may be in the form of specific feedback regarding the merchant that may be learned when meeting with the client or potential client. For example, the feedback may include errors in the merchant data or issues with the GUI.

FIG. 3 is a high level schematic illustration of a system 300 for providing data analytics and insights. The system 300 may include one or more merchants 302a, b, c, . . . n having point of sale devices. When one or more consumers are ready to purchase goods or services from the one or more merchants, they may be presented with the option to make a cash, credit or debit PIN transaction at the POS. Depending on the type of transaction selected (debit or credit), transaction data including the transaction amount, card number, and expiration date, along with merchant data and other information may be sent to an acquirer, such as first acquirer 304a or second acquirer 304b, which in turn sends the information to a payment network 306. The payment network 306 handles the processing of the transaction and may be, for example, STAR®, Pulse®, NYCE®, MAC®, MasterCard's Maestro® and Visa's Interlink®. The payment network 306 may also send the transaction data and merchant data to one or more data computing devices 308, which may be in communication with one or more merchant databases 310. In addition, acquirer data may also be sent via the payment network 306 to the one or more data computing devices 308. The one or more merchant databases 310 may store the transaction, merchant, and acquirer data for each of the merchants 302a, b, c, . . . n in the one or more merchant databases 310 as a first dataset, second dataset, etc. A computing device 312, such as computing device 102, may be in communication with the one or more data computing devices 308 and the one or more merchant databases 310.

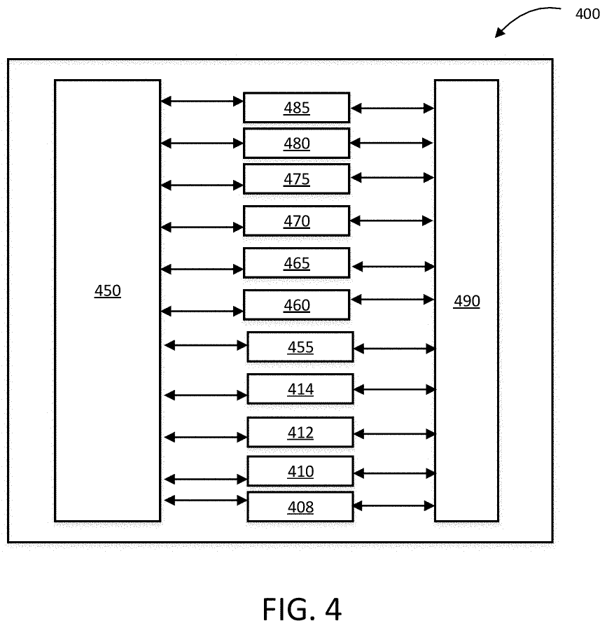

FIG. 4 may be an example computing device 400, such as computing device 102 or data computing device 308, which may be physically configured to interact with other computing devices, one or more merchant databases 310, the payment network 306, and various other components of system 300. The computing device 400 may have a processor 450 that is physically configured according to computer executable instructions. The computing device 400 may have a portable power supply 455 such as a battery which may be rechargeable. It may also have a sound and video module 460 which assists in displaying video and sound and may turn off when not in use to conserve power and battery life. The computing device 400 may also have volatile memory 465 and non-volatile memory 470, as well as internal storage 475 or external storage 480. The computing device 400 may have GPS capabilities 485 that may be a separate circuit or may be part of the processor 450. There also may be an input/output bus 490 that shuttles data to and from the various user input devices including a camera 408, a receiver 410, a display 412, such as display 101, and other inputs 414, etc. It also may control communicating with other computing devices and system components, either through wireless or wired devices. Of course, this is just one embodiment of the computing device 400 and the number and types of computing devices 400 is limited only by the imagination.

As a result of the methods, apparatuses, and systems disclosed herein, numerous technical problems may be addressed and solved. By consolidating different data and displaying it to a salesperson or merchant client, who is intimately familiar with the data, anomalies in the data can be detected and either removed promptly or the data can be updated in response to real time feedback from the user. In addition, the time it takes to answer specific questions about a merchant or market segment can be answered quickly and efficiently as a user only needs to go to one place rather than multiple systems or location for the relevant data; this in turn results in less processing time by various computers that are used to retrieve the information. By consolidating the information onto a single screen, the computing device displaying the information requires less processor time and resources as the user doesn't need to use a mouse or other input to scroll down or move between web pages.

In accordance with the provisions of the patent statutes and jurisprudence, exemplary configurations described above are considered to represent one embodiment of the disclosure. However, it should be noted that the teachings of the disclosure can be practiced otherwise than as specifically illustrated and described without departing from its spirit or scope.

The computing devices, computers, databases, and servers described herein may be computers that may have, among other elements, a microprocessor (such as from the Intel Corporation, AMD or Motorola); volatile and non-volatile memory; one or more mass storage devices (e.g., a hard drive); various user input devices, such as a mouse, a keyboard, or a microphone; and a video display system. The user computing devices, computers, and servers described herein may be running on any one of many operating systems including, but not limited to WINDOWS, UNIX, LINUX, MAC OS, or Windows (XP, VISTA, etc.). It is contemplated, however, that any suitable operating system may be used for the present disclosure. The servers may be a cluster of web servers, which may each be LINUX based and supported by a load balancer that decides which of the cluster of web servers should process a request based upon the current request-load of the available server(s).

The computing devices, computers, databases, and servers described herein may communicate via communications networks, including the Internet, WAN, LAN, Wi-Fi, cellular, or other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described figures, including any servers, point of sale terminals, computing devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present disclosure as described above can be implemented in the form of control logic using computer software in a modular or integrated manner. Based on the disclosure and teachings provided herein, a person of ordinary skill in the art may know and appreciate other ways and/or methods to implement the present disclosure using hardware, software, or a combination of hardware and software.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow diagram, a narrative, and/or in any other manner that provides sufficient structure for those of ordinary skill in the art to implement the recited process and its equivalents.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment. One or more features from any embodiment may be combined with one or more features of any other embodiment without departing from the scope of the disclosure. A recitation of “a”, “an” or “the” is intended to mean “one or more” unless specifically indicated to the contrary. Recitation of “and/or” is intended to represent the most inclusive sense of the term unless specifically indicated to the contrary.

Further, the figures depict exemplary embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

We claim:

1. A computer implemented method of minimizing computations required to display data via a graphical user interface on a computing device, the method comprising:
receiving a selection of a merchant from a user via a user selection button displayed on the graphical user interface;
determining, via a processor, a peer group for the merchant, wherein the peer group is comprised of one or more peer merchants that are in the same industry as the merchant;
receiving a first dataset having one or more merchant variables for the merchant;
receiving a second dataset having one or more peer variables for the peer group;
analyzing, via the processor, the first dataset to determine if one or more anomalies are present in the first dataset;
if one or more anomalies are present, removing the anomalies, via the processor;
displaying on the graphical user interface in graphical form the one or more merchant variables and the one or more peer variables.

2. The method of claim 1, wherein the first dataset is analyzed to determine if one or more anomalies exist by:
comparing the first dataset to the second dataset.

3. The method of claim 2, wherein the one or more merchant variables of the first dataset include a plurality of merchant category codes for the merchant in a first location and the one or more peer variables of the second dataset include a plurality of peer merchant category codes for one or more peers of the merchant in the first location.

4. The method of claim 3, wherein an anomaly exists if any of the merchant category codes from the plurality of merchant category codes does not match any of the peer merchant category codes from the plurality of peer merchant category codes.

5. The method of claim 3, wherein the first location is a city, state, country, or region.

6. The method of claim 1, wherein the first dataset is analyzed to determine if one or more anomalies exist by:
comparing the one or more merchant variables of the first dataset.

7. The method of claim 6, wherein the one or more merchant variables of the first dataset comprises a first plurality of merchant category codes of the merchant at a first location and a second plurality of merchant category codes for the merchant at a second location.

8. The method of claim 7, wherein an anomaly exists if any of the merchant category codes from the first plurality of merchant category codes does not match any of the merchant category codes from the second plurality of merchant category codes.

9. The method of claim 7, wherein the first location is a city, state, country, or region.

10. The method of claim 7, wherein the first location is different from the second location.

11. The method of claim 1, further comprising:
storing the first dataset and the second dataset on a merchant database.

12. The method of claim 11, wherein the merchant database is in communication with the computing device.

13. The method of claim 12, further comprising:
displaying a widget on the graphical user interface.

14. The method of claim 13, further comprising:
adding data to the first dataset or second dataset using the widget.

15. The method of claim 13, wherein the widget is displayed on the graphical user interface as an icon.

16. The method of claim 1, wherein the first dataset is received from a first acquirer.

17. The method of claim 1, wherein the second dataset is received from a second acquirer.

18. The method of claim 1, wherein the computing device is a portable computing device.

19. A processor-readable tangible non-transitory medium storing processor-issuable instructions configured to cause a processor to:
display data on a computing device via a graphical user interface;
receive a selection of a merchant from a user via a user selection button displayed on the graphical user interface;
determine a peer group for the merchant, wherein the peer group is comprised of one or more peer merchants that are in the same industry as the merchant;
receive a first dataset having one or more merchant variables for the merchant;
receive a second dataset having one or more peer variables for the peer group;
analyze, via the processor, the first dataset to determine if one or more anomalies are present in the first dataset;
if one or more anomalies are present, removing the anomalies, via the processor;
display on the graphical user interface in graphical form the one or more merchant variables and the one or more peer variables.

20. A system for displaying merchant data, comprising:
a computing device having a graphical user interface;
a database in communication with the computing device; and
a processor in communication with the computing device and the database,
wherein the database is configured to:
receive and store a first dataset having one or more merchant variables for a merchant;
receive and store a second dataset having one or more peer variables for a peer group of the merchant;
wherein the processor is configured to:
determine the peer group for a merchant, wherein the peer group is comprised of one or more peer merchants that are in the same industry as the merchant;
analyze the first dataset to determine if one or more anomalies are present in the first dataset;
if one or more anomalies are present, removing the anomalies;
send the one or more merchant variables and the one or more peer variables to the computing device;
wherein the computing device is configured to:
receive a selection of the merchant from a user via a user selection button displayed on the graphical user interface; and
display on the graphical user interface in graphical form the one or more merchant variables and the one or more peer variables.
